(19) United States
(12) Patent Application Publication
(10) Pub. No.: US 2014/0130478 A1
(43) Pub. Date: May 15, 2014

(54) GAS TURBOMACHINE INCLUDING A FUEL PRE-HEAT SYSTEM

(71) Applicant: GENERAL ELECTRIC COMPANY, Schenectady, NY (US)

(72) Inventors: Bhaskar Pemmi, Bangalore (IN); Joseph John, Bangalore (IN); Indrajit Mazumder, Bangalore (IN)

(73) Assignee: GENERAL ELECTRIC COMPANY, Schenectady, NY (US)

(21) Appl. No.: 13/673,217

(22) Filed: Nov. 9, 2012

(51) Int. Cl. F02C 7/224; F02C 3/22

(52) U.S. Cl. CPC F02C 7/224; F02C 3/22
USPC 60/39.465; 60/736; 60/772

(57) ABSTRACT

A gas turbomachine includes a compressor portion, a turbine portion operatively connected to the compressor portion, a combustor assembly including at least one combustor fluidically connected to the turbine portion, and an accessory mechanically linked with and driven by the turbine portion. The gas turbomachine also includes a fuel pre-heat system including a fuel pre-heat element having a fuel circuit fluidically connected to the at least one combustor arranged in a heat exchange relationship with a heating medium circuit fluidically connected to at least one of the compressor portion, the turbine portion, and the accessory.

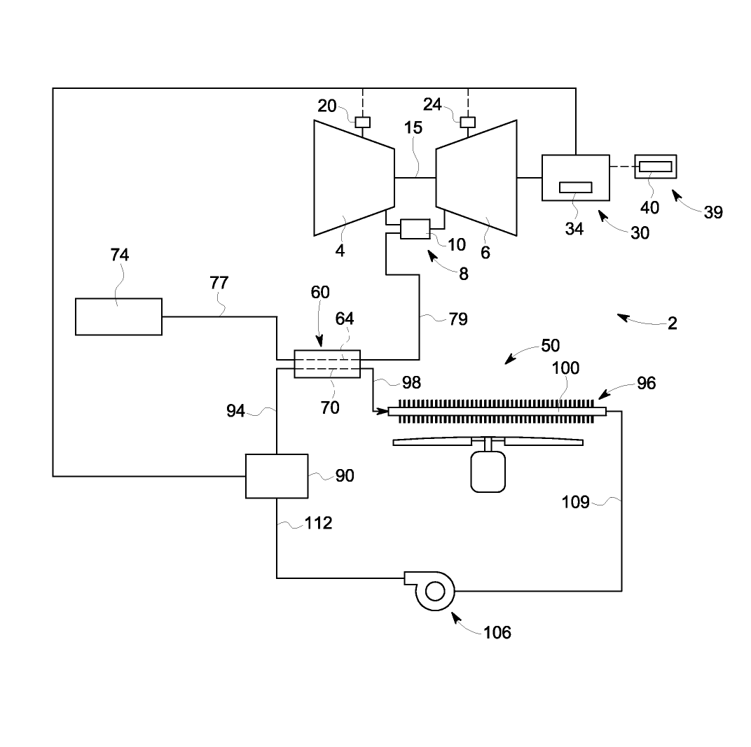

### BACKGROUND OF THE INVENTION

The subject matter disclosed herein relates to the art of turbomachines and, more particularly, to a gas turbomachine including a fuel pre-heat system.

Gas turbomachines include a compressor portion linked to a turbine portion through a common compressor/turbine shaft and a combustor assembly. An inlet airflow is passed through an air intake toward the compressor portion. In the compressor portion, the inlet airflow is compressed through a number of sequential stages toward the combustor assembly. In the combustor assembly, the compressed airflow mixes with a fuel to form a combustible mixture. The combustible mixture is combusted in the combustor assembly to form hot gases. The hot gases are guided to the turbine portion through a transition piece. The hot gases expand through the turbine portion acting upon turbine blades mounted on wheels to create work that is output, for example, to power a generator, a pump, or to provide power to a vehicle.

Often times it is desirable to pre-heat the fuel prior to combustion. For example, liquid natural gas (LNG) is stored as a low temperature fluid. In many cases, the LNG is stored at temperatures at or below −260° F. (−162° C.). For combustion purposes, it is desirable to heat the LNG to between about 80° F. and about 120° F. (26.6° C.-48.8° C.). Heating the LNG gasifies the liquid for introduction to the combustor. At present, gas turbomachine systems include a dedicated fuel heater. Heat rejected by the fuel heater after gasifying the LNG is released to ambient.

### BRIEF DESCRIPTION OF THE INVENTION

According to one aspect of an exemplary embodiment, a gas turbomachine includes a compressor portion, a turbine portion operatively connected to the compressor portion, a combustor assembly including at least one combustor fluidically connected to the turbine portion, and an accessory mechanically linked with and driven by the turbine portion. The gas turbomachine also includes a fuel pre-heat system including a fuel pre-heat element having a fuel circuit fluidically connected to the at least one combustor arranged in a heat exchange relationship with a heating medium circuit fluidically connected to at least one of the compressor portion, the turbine portion, and the accessory.

According to another aspect of the exemplary embodiment, a method of pre-heating fuel for a gas turbomachine includes guiding an amount of fuel at a first temperature into a fuel circuit of a fuel pre-heat element, passing a heating medium at a second temperature through a component operatively associated with the gas turbomachine, raising the second temperature to a third temperature in the component, passing the heating medium at the third temperature into a heating medium circuit of the fuel pre-heat element, exchanging heat between the heating medium and the fuel in the fuel pre-heat element, heating the fuel to a fourth temperature that is higher than the first temperature and lower than the third temperature in the fuel pre-heat element, and guiding the fuel at the fourth temperature into a combustor of the gas turbomachine.

These and other advantages and features will become more apparent from the following description taken in conjunction with the drawing.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawing in which:

The FIGURE is a schematic representation of a gas turbomachine including a fuel pre-heating system in accordance with an exemplary embodiment.

The detailed description explains embodiments of the invention, together with advantages and features, by way of example with reference to the drawing.

### DETAILED DESCRIPTION OF THE INVENTION

A gas turbomachine in accordance with an exemplary embodiment is indicated generally at 2 in the FIGURE. Gas turbomachine 2 includes a compressor portion 4 fluidically connected to a turbine portion 6 through a combustor assembly 8. Combustor assembly 8 includes at least one combustor 10. Combustor assembly 8 may also include a plurality of combustors arranged in, for example, a can-annular array. Of course it should be understood that other combustor arrangements may also be employed. Compressor portion 4 is also mechanically linked to turbine portion 6 through a common compressor/turbine shaft 15. Compressor portion 4 is shown to include a cooling member 20. Cooling member 20 may take the form of a lube oil cooler and/or a purge cooler. Turbine portion 6 is also shown to include a cooling member 24 which, as discussed above, may take the form of a lube oil cooler and/or a purge cooler. Turbine portion 6 is also mechanically linked to an accessory 30. Accessory 30 may take the form of a generator, a pump, or some other mechanically driven device. In the case of a generator, accessory 30 may include a generator cooler 34. Accessory 30 may also be connected to a load commutated inverter (LCI) 39 having an LCI cooler 40.

In accordance with an exemplary embodiment, gas turbomachine 2 also includes a fuel pre-heat system 50 that raises a temperature of fuel passing to combustor 10. Fuel pre-heat system 50 includes fuel pre-heat element 60 including a fuel circuit 64 arranged in a heat exchange relationship with a heating medium circuit 70. Fuel circuit 64 is fluidically connected with a fuel source 74 through a conduit 77 and to combustor 10 through a conduit 79. In accordance with an aspect of the exemplary embodiment, fuel pre-heat element 60 passes liquid natural gas (LNG) at a first temperature, generally at or below −260° F. (−162° C.) into fuel pre-heat element 60. In fuel pre-heat element 60, the LNG gasifies and exits at a second temperature that is higher than the first temperature. In accordance with an aspect of the exemplary embodiment, the fuel exits fuel pre-heat element 60 at about 40° F.-120° F. (4.4° C.-48.9° C.) prior to introduction into combustor 10. The fuel is heated by being passed in a heat exchange relationship with a heating medium flowing through heating medium circuit 70. As will be discussed more fully below, the heating medium takes the form of a fluid that has extracted heat from compressor portion 4, turbine portion 6, and/or accessory 30.

In further accordance with an exemplary embodiment, heating medium circuit 70 is fluidically connected to fluid reservoir 90 that is fluidically connected with one or more of cooling member 20, cooling member 24, generator cooler 34, and/or LCI cooler 40. Specifically, a heating medium, such as a coolant in the form of oil, extracts heat from one or more heat loads associated with compressor portion 4, turbine portion 6, and/or accessory 30. The heating medium exits fluid reservoir 90 through a conduit 94 at a third temperature that is higher than both the first and second temperatures and enters fuel pre-heat element 60. The heating medium exchanges heat with the fuel and exits pre-heat element 60 at a fourth temperature that is lower than the third temperature and flows to a heat exchanger 96 through a conduit 98. In the exemplary embodiment shown, heat exchanger 96 takes the form of a fin-fan cooler 100. The heating medium flows from heat exchanger 96 at a fifth temperature that is lower than the fourth temperature. The heating medium flows to a pump 106 through a conduit 109 and back to fluid reservoir 90 through a conduit 112 forming a closed loop fluid circuit.

At this point it should be understood that the exemplary embodiments describe a fuel pre-heat system that employs waste heat rejected from one or more components associated with a gas turbomachine to pre-heat fuel prior to being introduced to a combustor. The rejected heat is passed into a fluid medium that is passed in a heat exchange relationship with fuel. In addition to pre-heating fuel, the pre-heat system also provides an initial cooling to the fluid medium prior to passing to a heat exchanger. In this manner, the fuel pre-heat system also enables that use of a heat exchanger having a smaller heat exchange capacity and thus a much smaller foot print than is currently required. It should also be understood that while described in terms of gasified liquid natural gas, the fuel pre-heat system cam be employed to provide an initial pre-heat to a wide range of fuel types. Also, it should be understood that the source of waste may vary in accordance with the exemplary embodiment.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A gas turbomachine comprising:
a compressor portion;
a turbine portion operatively connected to the compressor portion;
a combustor assembly including at least one combustor fluidically connected to the turbine portion;
an accessory mechanically linked with and driven by the turbine portion; and
a fuel pre-heat system including a fuel pre-heat element having a fuel circuit fluidically connected to the at least one combustor arranged in a heat exchange relationship with a heating medium circuit fluidically connected to at least one of the compressor portion, the turbine portion, and the accessory.

2. The gas turbomachine according to claim 1, wherein the fuel pre-heat system includes a heat exchanger fluidically connected to the heating medium circuit.

3. The gas turbomachine according to claim 2, wherein the heat exchanger comprises a fin-fan cooler.

4. The gas turbomachine according to claim 1, wherein the accessory comprises a generator including a generator cooler, the heating medium circuit being fluidically connected to the generator through the generator cooler.

5. The gas turbomachine according to claim 1, further comprising: a load commutated inverter (LCI) having an LCI cooler operatively connected to the accessory, the heating medium circuit being fluidically connected to the accessory through the LCI cooler.

6. The gas turbomachine according to claim 1, further comprising: a lube oil cooler operatively associated with one of the compressor portion and the turbine portion, the heating medium circuit being fluidically connected to the one of the compressor portion and the turbine portion through the lube oil cooler.

7. The gas turbomachine according to claim 1, further comprising: a purge air cooler operatively associated with one of the compressor portion and the turbine portion, the heating medium circuit being fluidically connected to the one of the compressor portion and the turbine portion through the purge air cooler.

8. The gas turbomachine according to claim 1, further comprising: a pump fluidically connected with the heating medium circuit, the pump being configured and disposed to urge a fluid through the heating medium circuit.

9. The gas turbomachine according to claim 1, further comprising: a source of liquid fuel fluidically connected to the fuel pre-heat element.

10. The gas turbomachine according to claim 9, wherein the source of liquid fuel comprises a source of liquid natural gas (LNG).

11. A method of pre-heating fuel for a gas turbomachine, the method comprising:
guiding an amount of fuel at a first temperature into a fuel circuit of a fuel pre-heat element;
passing a heating medium at a second temperature through a component operatively associated with the gas turbomachine;
raising the second temperature to a third temperature in the component;
passing the heating medium at the third temperature into a heating medium circuit of the fuel pre-heat element;
exchanging heat between the heating medium and the fuel in the fuel pre-heat element;
heating the fuel to a fourth temperature that is higher than the first temperature and lower than the third temperature in the fuel pre-heat element; and
guiding the fuel at the fourth temperature into a combustor of the gas turbomachine.

12. The method of claim 11, further comprising: passing the heating medium at a fifth temperature that is lower than the third temperature through a heat exchanger.

13. The method of claim 12, wherein passing the heating medium through the heat exchanger includes passing the heating medium through a fin-fan cooler.

14. The method of claim 11, wherein heating the fuel to the fourth temperature comprises converting the fuel from a liquid state to a gaseous state.

15. The method of claim 14, wherein converting the fuel from a liquid state to a gaseous state comprises gasifying liquid natural gas (LNG).

16. The method of claim 11, wherein passing the heating medium through a component operatively associated with the gas turbomachine includes passing the heating medium through a generator cooler.

17. The method of claim 11, wherein passing the heating medium through a component operatively associated with the gas turbomachine includes passing the heating medium through a load commutated inverter (LCI) cooler.

18. The method of claim 11, wherein passing the heating medium through a component operatively associated with the gas turbomachine includes passing the heating medium through a lube oil cooler.

19. The method of claim 11, wherein passing the heating medium through a component operatively associated with the gas turbomachine includes passing the heating medium through a purge air cooler.

20. The method of claim 11, wherein passing the heating medium into the heating medium circuit comprises pumping the heating medium through a closed loop fluid circuit.
